(19) United States
(12) Patent Application Publication
(10) Pub. No.: US 2022/0253941 A1
(43) Pub. Date: Aug. 11, 2022

(54) SAFE DRIVING MONITORING AND INCENTIVE SYSTEM

(71) Applicant: KARCHING INC., Chicago, IL (US)

(72) Inventors: Ramsey GOUDA, Chicago, IL (US); Richard CROSS, Chicago, IL (US); William MURRAY, Chicago, IL (US); Earl GERO, Chicago, IL (US)

(21) Appl. No.: 17/433,104

(22) PCT Filed: Feb. 24, 2020
(86) PCT No.: PCT/US20/19554

§ 371 Date: Aug. 23, 2021

Related U.S. Application Data
(60) Provisional application No. 62/808,996, filed on Feb. 22, 2019.
(60) Provisional application No. 62/895,987, filed on Sep. 4, 2019.

(51) Int. Cl. G06Q 40/08; G07C 5/08; H04W 4/02

(52) U.S. Cl. CPC G06Q 40/08; H04W 4/025; G07C 5/0841

(57) ABSTRACT

A safe driving incentive system is used to track and train new drivers in license acquisition procedures and may encourage new drivers to adopt the safe driving incentive system for future driving incentives and insurance premium deductions. An incentive company receives a system payment from a payer, such as a parent, and facilitates payment of a customer's premium to an insurance company. The system payment may be greater than the insurance premium and the incentive company may utilize this balance in the account to pay a designated monitored driver a reward payment for safe driving. The safe driving incentive system utilizes a location services system which may employ a global positioning system on a mobile phone or in the vehicle to monitor the driver. Telematic may be used to determine a driver rating that impacts the insurance premium and the reward payment to a monitored driver.

### CROSS REFERENCE TO RELATED APPLICATIONS

This application claims the benefit of priority to U.S. provisional patent application Ser. No. 62/808,996, filed on Feb. 22, 2019, and to U.S. provisional patent application Ser. No. 62/895,987, filed on Sep. 4, 2019; the entirety of both applications are hereby incorporated by reference herein.

### BACKGROUND OF THE INVENTION

### Field of the Invention

The present invention relates to a provisionally-licensed driver monitoring and recording system and a safe driving incentive system that monitors drivers through telematics and pays drivers for safe driving through an incentive company and wherein the incentive company may interface an insurance company to facilitate making an insurance premium payment, such as through application program interface (API).

### Background

Some automotive insurance companies monitor driving to determine a premium rate and or discount rate off of full price for the driver. These systems use standardized telematics outputs which are monitored using car-based sensors, an On-board diagnostic (OBD) device, or a program installed upon a mobile device, to monitor speeding, hard acceleration/deceleration, sharp turns and other telematic parameters that are tied to vehicle motion. However, one of the biggest impediments to safe driving is the use of mobile devices while driving. Texting and driving is well known to be the cause of many accidents. Talking on the phone is also very distracting and many states laws against texting and driving and/or talking on the phone while driving. Hands free phone communication is typically accepted. Young people, such as teenagers, are often consumed by their mobile phone, texting often throughout the day. These new drivers may be prone to distraction while driving due to the use of their mobile phone. This situation concerns the parents of these new, easily distracted, drivers. There exists a need for an effective incentive system that promotes safe driving, especially for new teenage drivers.

Currently most states and other legal jurisdictions issue driving licenses and require that provisionally-licensed drivers accumulate a fixed number of hours of driving experience while accompanied by an experienced licensed driver, a supervisor, before the provisionally-licensed driver is eligible to take a test for a full driver's license. The precise specifics of the requirements vary according to state and jurisdiction, however the common denominator in most of these jurisdictions is that the provisionally-licensed driver be able to present a written log specifying:

The number of total hours driven with each supervisor during daytime;

The number of the hours driven at night; and

The log of dates on which the supervised driving trips occurred.

Typically, this is being accomplished with nineteenth century technology of pencils, paper and a printed logbook. This is subject to many problems involving accuracy, diligence, and non-technical verification of any kind in such a system after each trip; all related to the “human inaccuracies, shortfalls and limitations” of the recording parties. There exists a need for an effective method to monitor and record provisionally-licensed driver time.

### SUMMARY OF THE INVENTION

An exemplary provisionally-licensed driver monitoring and recording system and a safe driving incentive system monitors a monitored driver through a telematics system and/or a location services system that may operate on a mobile device, such as a mobile phone, or through the use of a vehicle based location services system or auxiliary on board device, or some combination thereof. In an exemplary embodiment, a provisionally-licensed driver monitoring and recording system monitors a provisionally-licensed driver and monitors and measures the hours of driving time including day and night-time driving hours and may also determine a driver rating. The provisionally-licensed driver may have to accumulate a certain number of hours of driving and may have to meet an acceptable driver rating before the provisionally-licensed drive receives a driver's license.

An exemplary safe driving incentive system monitors a driver, which may be a child, whereby the parent may make payments into the system and wherein a reward payment may be made to child as a reward payment for safe driving, wherein the reward payment may effectively be a payment directly from their parent and facilitated by the inventive company. A system payer, such as a parent, may make an incentive payment into the system and the reward payment made to the child may be determined after a cycle time of driving and may be based on the child's driver rating.

A system payer may also make system payments into the system and insurance premiums for the system payer and/or child may be facilitated by the incentive company. The insurance premiums may be discounted due to safe driving as determined by a monitoring system that calculates a driver rating. Any insurance premium discounts or reductions earned through safe driving may be available to the child as a reward payment. In addition, a parent may make incentive payments into the system to further incentivize the child to drive safely. The child may be encouraged to drive safely in order to receive the maximum reward payment. In addition, the child may increase the reward payment by continued lowering the insurance premiums through safe driving. The reward payment may be made from the incentive company directly to the monitored driver, whereby the insurance company does not pay out any funds as a premium discount.

In an exemplary embodiment, a provisionally-licensed driver monitoring and recording system is configured to monitor driving of a provisionally-licensed driver with one or more licensed drivers. An exemplary provisionally-licensed driver monitoring and recording system may be an automatic system, such as an application software (App) that runs on a pair of mobile devices, such as mobile phones to determine when the provisionally-licensed driver is driving with a licensed driver. A provisionally-licensed driver, or a licensed driver, such as a parent, may input identifying information of licensed drivers that the provisional licensed driver may train with. For example, the provisionally-licensed driver, or a licensed driver, may download the provisionally-licensed driver App on their phone and the App may request input for licensed drivers and/or the provisionally-licensed driver. The App may then send out request to these drivers to download the App on their phone. For example, a text may be sent to these identified drivers to download the App. The system may then function to monitor the provisionally-licensed driver and the registered licensed driver to determine when they have driven together. When the provisionally-licensed driver conducted a training drive, or trip, the App may request confirmation of the training drive.

An exemplary provisionally-licensed driver monitoring and recording system utilizes an App, to monitor the provisionally-licensed driver and determine when they are traveling in a vehicle, such as a car. For example, when the provisionally-licensed driver App detects, through the global positioning system GPS of the provisionally-licensed driver's phone, that the provisionally-licensed driver is traveling above a threshold driving speed, of about 20 mph or more, the system may then compare the location and route of the provisionally-licensed driver with the registered licensed drivers, or supervisors. When the system detects that the provisionally-licensed driver and one or more of the supervisor drivers traveled together, a training drive confirmation may be provided on the provisionally-licensed driver's phone or one of the supervisor driver's phone for confirmation. In this way, trips where the provisionally-licensed driver was a passenger will not be counted toward the duration or miles of supervised driving required for obtaining a license.

An exemplary provisionally-licensed driver App uses third-party telematics software which has been enabled to begin recording a training trip upon the discovery that the provisionally-licensed driver and one or more supervisor drivers have traveled together above a threshold driving speed and in some cases for some threshold period of time or for some threshold distance. The threshold period of time may be at least 5 minutes or more, at least 10 minutes or more, and the threshold distance may be at least 1 mile, at least 2 miles, at least 3 miles, or at least 5 miles.

A map display may be provided on the provisionally-licensed driver's and/or a supervisor driver's phone after a potential training drive has been detected. The map display may show the route taken by both the provisionally-licensed driver and the supervisor driver. A training drive confirmation may be displayed for the provisionally-licensed driver or the supervisor driver to confirm that the trip was a training drive. This confirmation may be sent only to the supervisor driver to avoid the provisionally-licensed driver falsely confirming training driving events. A training drive confirmation message may also be provided at the beginning of a potential training drive trip, upon the detection of both the provisionally-licensed driver and the supervisor driver traveling together above a driving threshold speed, for example.

Any of the safe driving metrics and monitoring features described herein may be implemented during a potential training drive trip and may be displayed to the provisionally-licensed driver or licensed supervisor driver(s) on the trip. When a trip is confirmed as a training trip, the driving metrics for the provisionally-licensed driver may be recorded. Any violations may be provided to a third party and the provisionally-licensed driver may have to meet performance or driver rating, as described herein, before they are eligible for a driver's license.

The provisionally-licensed driver App may use a monitoring system as described herein and may us any of the various location services systems to determine a driver rating, including telematics data generated by both the provisionally-licensed driver's and supervisor driver's mobile phone Apps. The data may be transmitted to a central database having a server marked with either a “provisionally-licensed driver” or a “supervisor” tag accompanying all transmitted data. The database and server may be cloud based. The database and server may be cloud based.

The provisionally-licensed driver and any supervisor drivers may have to enable the provisionally-licensed driver App to have access to GPS data and to other functions of the mobile phone. The provisionally-licensed driver and supervisor drivers may be able to activate and deactivate the provisionally-licensed driver App as desired.

In an exemplary embodiment, each day, at a set time, the server will run an algorithm which is designed to:
Identify, by means of a unique tag tied to the installation of the application installed upon the phone of the provisionally-licensed driver, all recorded trips which are associated with each provisionally-licensed driver for that day;
Identify, by means of a unique tag tied to the instantiation of the application installed upon the phone of the supervisor or supervisors, all recorded trips which are associated with an application found upon the phone of a supervisor who is linked to the provisionally-licensed driver for that day; compare each provisionally-licensed and supervisor trip to find an approximate match in starting latitude and longitude; compare each provisionally-licensed trip and supervisor trip to find an approximate match in stopping latitude and longitude; compare each provisionally-licensed trip and supervisor trip to find an approximate match in starting time; and compare each provisionally-licensed trip and supervisor trip to find an approximate match in stopping time.

The server may then use comparison criteria to determine if a trip was “a trip accompanied by a supervisor.” If so, it will record this “co-incident trip” in an automated logbook reserved for the provisionally-licensed driver.

Co-incident trips where the participating parties recall that the provisionally-licensed driver was not driving an automobile during that trip can be rendered “invalid” by a supervisor.

For teaching and in-class use cases, where there maybe multiple students in an in-vehicle training session, in order to give an instructor a degree of control over a ‘multiple-student scenario’, a “training drive confirmation” message may be sent to the supervisors phone—or the provisionally-licensed driver's phone—for confirmation or negation that they were or were not the particular student driving. We will allow both to confirm which scenario is the case for verification, and in this case they both would indicate that that student is a ‘passenger’ in a multiple-student, in-vehicle training drive, whereby they can opt out so as to not count that drive in their hours log. In this way, trips where the provisionally-licensed driver was a passenger will not be falsely counted toward the duration or miles of supervised driving required for obtaining a license.

A provisionally-licensed driver, or a licensed driver, such as a parent, may input identifying information of licensed drivers that the provisional licensed driver may train with. For example, the provisionally-licensed driver, or a licensed driver, may download the provisionally-licensed driver App on their phone and the App may request input for licensed drivers and/or the provisionally-licensed driver. The App may then send out request to these drivers to download the App on their phone. For example, a text may be sent to these identified drivers to download the App. The system may then function to monitor the provisionally-licensed driver and the registered licensed driver to determine when they have driven together. When the provisionally-licensed driver conducts a training drive, or trip, the App may request confirmation of the training drive with a parent or teacher.

By logging into the server using the account associated with the provisionally-licensed driver, a table may be displayed which lists all co-incident trips. Each trip may be divided into “daytime” and “nighttime” minutes which will be accumulated separately for recording purposes. This table may have the ability to mark any given trip as “invalid.”

In an exemplary embodiment, at the end of such time that the requisite number of hours and minutes of both daytime and nighttime driving are accumulated under whatever prescribed range of days which are required within the jurisdiction where it is employed, the users may create a copy of the table which prints all valid co-incident trips together with the identifying information pertinent to said trips. This table may be stored as a PDF file, which will then be emailed to the designated address assigned to the account, complete with delimited space reserved for signature(s) of supervisor(s).

A provisionally-licensed driver may take a picture of themselves behind the wheel and/or a supervisor in the vehicle and this may be saved in the App for review later. The photographs may be reviewed by another supervisor or administrator to determine if a driving trip should be included as a training driving trip. For example, an older sister may be a qualified supervisor driver and the image may confirm to a parent that the provisionally-licensed driver was driving with their sister as a supervisor.

In an exemplary embodiment, a safe driving incentive system utilizes an incentive company that receives a payment from a system payer, such as a parent, and the incentive company, in turn, facilitates making a reward payment, a parental incentive reward, to a monitored driver, such as a child, for safe driving. A monitoring system monitors driving of the monitored driver and determines a driver rating. The child's reward payment may be determined based on this driver rating after a cycle time. The cycle time may be a week, or month, for example. The incentive company may manage the monitoring system and may manage or facilitate receiving the payments from the system payer and making of the reward payments to a monitored driver.

An exemplary safe driving incentive system may also interface with an insurance company and facilitate or manage insurance premium payments for a system payer to an insurance company. The incentive company may receive the payments from the system payer or from a financial institution, which may be a private equity institution, private capital institution, credit company, private individual or individuals. The incentive company may manage the payment of the reward payment to the monitored driver. A premium balance is the balance of a system payment and the insurance premium paid to the insurance company. This premium balance may be paid to the system payer, or a monitored driver that may be on the system payer's insurance policy as a reward payment and as an incentive to drive safely. The monitored driver may reduce the premiums by having and maintaining a high driver rating and this reduced premium, or premium discount, may result in a higher premium balance and therefore a higher reward payment. The system payer may determine what portion of the premium balance and any reward balance from previous cycles will be paid out. In addition, the system payer may pay an additional incentive payment into the system which may be available as a reward payment. The system will track and monitor driving to determine a driver rating and this driver rating may result in changes to the insurance premium wherein a high driver rating for safe driving will result in a reduced insurance premium and therefore more money in the reward bank for reward payments to the payer or a monitored driver. If, however, the monitored driver has a low driver rating and the insurance premiums go up, the amount available as a reward payment will be reduced or eliminated.

An exemplary safe driving incentive system utilizes a location services system to monitor the location of a monitored vehicle and the driving metrics, such as by telematics. A location services system may be configured on a mobile phone or may be configured in the vehicle and be part of the vehicle, or may operate in part through the vehicle, or may utilize an On-board diagnostic (OBD) device. An exemplary OBD device is an OBD II device, such as available from Automatic Pro. An OBD device may be plugged into a port of the vehicle, such as an OBD port or a USB port. An OBD device and location services system may communicate data wirelessly through a wireless transmitter to a database. A location services system may utilize GPS, WIFI signals, triangulation upon cell towers and other method to determine the location of a monitored vehicle and other driving or vehicle metrics, such as speed, acceleration and the like. An exemplary location services system may compare the monitored vehicles speed with respect to a posted speed limit, based on the roadway location of the vehicle, and determine if the vehicle is traveling above the speed limit. An exemplary location services system may utilize any of the devices sensors and location services to determine the position and motion of the vehicle including GPS, cell phone towers triangulation and WIFI signal mapping. An exemplary OBD may pull data from the car, such as vision system data including lane departures and forward vehicle following distances. Also, a vehicle may have a beacon that utilizes a near field system to determine the location of the vehicle. The system may utilize a proprietary beacon to determine the location of the drivers within a vehicle to determine which one is driving and which one is a passenger. Seat weight sensors may also be used to differentiate between driver and passenger in a vehicle.

An incentive system may utilize telematics data or other vehicle monitoring data collected by other companies, such as through an insurance company app, to determine and recommend a suggested reward payment. This data may be collected by interfacing with an existing insurance company driver monitoring App that operates on consumer's mobile devices. The recommended reward may match the insurance discount earned by the driver through the insurance company app. The incentive company may collect data from the insurance company's monitoring system by interfacing via the monitored driver's mobile phone. The incentive system App may interface with an insurance company's App to collect data regarding the monitored driver's driving, including acquiring telematics data, premium amounts, premium discounts and the like. This data may be used by the incentive company to determine a reward payment amount. The reward payment may be the same or a portion of the premium discount determined by the insurance company through the monitored driving. A monitored driver may be required to provide permission for access to the insurance company's App for this data transfer to occur.

An exemplary location services system is configured with a mobile device, such as a mobile phone and may operate as a phone App or system App. The system App may monitor the monitored driver's driving through telematics and interfacing with the mobile phones global positioning system (GPS). The system App may utilize the GPS of the mobile phone and mapping software to determine what roadway the driver is driving on and may also determine if the driver is speeding. The system App may detect when the monitored driver is speeding, by utilizing the GPS function of the mobile phone and determining the location and posted speed limit of the roadway. The system App may be configured to provide an audible alert or alarm through the mobile phone speaker when it detects that the monitored driver is speeding.

The system App may also detect when the driver is texting or talking on the phone while driving. The system App may monitor the mobile phone usage and determine if the driver is using the system App and/or other apps during driving. If the system App is not in-focus, open on the front page/foreground of the mobile phone during a driving event, it may mean by default that other apps are open on the mobile device in front of the incentive App and the driver rating may be reduced. The system App may disable texting functions while the monitored driver is driving. A driver rating may be calculated based on the monitored drivers driving metrics, speeding, use of mobile phone and the like. The reward payment may be determined by the driver rating. Both the driver rating and reward payment may be displayed on the monitored driver's mobile phone to enable the monitored driver to keep track of how they are doing and to provide a real time incentive. The payer or parent may also have a system App and may also track the monitored driver's metrics, driver rating, infractions, driving times, driving locations, etc. Note that the location services system may operate through the vehicle or an OBD and a system App may enable the functions as outlined herein.

An exemplary monitoring system may utilize the location services system to determine acceleration, deceleration or turning acceleration, such as due to hard turning. The safe driving incentive system may have an acceleration threshold and when a monitored driver exceeds the acceleration threshold, a driver rating may be reduced. Likewise, the safe driving incentive system may have deceleration threshold and when a monitored driver exceeds the deceleration threshold, a driver rating may be reduced. A deceleration threshold may be utilized to determine hard breaking which may signify unsafe driving. A turning acceleration may be used to determine taking corners too rapidly and if a monitored driver exceeds a turning acceleration threshold their driver rating may be reduced.

An exemplary monitoring system may also utilize crash prevention systems or vehicle roadway monitoring system that may include a vision system that determine if the vehicle is staying in the lane, or determine a distance between the monitored vehicle and a forward vehicle. These vision systems may provide data to the monitoring system and may impact the driver rating. For example, if a vision system detects that the vehicle has too many lane departures, veering out of the lane, the driver rating may be reduced. Also, if the vision system determines that the monitored driver is tailgating or is too close to a forward vehicle for a certain duration, or a percentage of a traveling distance or trip, the driver rating may be reduced. As with the speeding notification, the safe driving incentive system may alert the driver if they outside of these metric limits. For example, the system may provide an audible alert if the vehicle veers out of the lane. Likewise, an audible alert may be initiated if the monitored vehicle is tailgating, or traveling within a threshold distance of a forward vehicle.

In an exemplary embodiment, the safe driving incentive system App detects when the monitored driver is moving above a threshold speed, such as about 8 mph or more, or about 10 mph or more, or about 20 mph or more and may request confirmation of driving. An exemplary driving event confirmation feature may automatically initiate when the App detects that the monitored driver is moving above the threshold speed. The monitored driver may confirm that they are driving, or may confirm that they are a passenger. An exemplary passenger confirmation feature may require the monitored drive to take a photograph using their mobile phone of the driver of the vehicle. This photograph may be date and time stamped and stored for an administrator, such as a parent, to confirm and remove from a monitored driver's driving log. A driving event log may display details of individual driving events for a monitored driver including but not limited to, the date of the driving event, the beginning and end locations of the driving event, the time of the driving event, the duration and the driver rating for that particular driving event. In addition, passenger driving events may also be listed on the driving event log and an administrator may select the passenger driving event, view the stored photograph and then confirm that is was a passenger event. The administrator may be able to delete passenger driving events and/or driving events from the driving event log. The driving event log may be displayed on both the monitored driver's mobile phone and the system payer or administrator's mobile phone, however only the administrator may have rights to confirm passenger driving events and delete driving events from the log.

In an exemplary embodiment, the monitored driver's rating is determined in real time, whereby each instance of speeding reduces the driver rating. There system may allow for slight speeds over the posted speed limit or for short durations of excess speeds over the speed limit. In an exemplary embodiment, these parameters may be set by a parent, such as no more than 5 mph over the speed limit, or no more than 10% over the posted speed limit. If the parent set a 5 mph reward over the posted speed limit, the driver may drive 60 mph in a 55 mph posted speed zone without reducing their driver rating and therefore reducing their reward payment. Likewise, the system may allow for short driving durations over the posted or allowed speed limit, such as no more than 30 seconds, no more than 1 minute, no more than 5 minutes and the like. These excess speeds may be allowed to enable the monitored driver to pass another car, for example.

An exemplary a safe driving incentive system may provide alerts to the monitored driver and/or the payer, such as the parent, when there are driving infractions including speeding, texting while driving and/or talking on the phone while driving. When the monitored driver is driving, the system App may produce an audible alert when speeding is detected and a notice may also be sent to the payer. Likewise, the system App may produce an audible alert when the monitored driver interfaces with their phone while driving, such as texting while driving. Again, an exemplary system App may disable texting while driving to prevent distractions. Use of the mobile phone including texting may be allowed when the vehicle is stopped, such as at a stop light however. The incentive may be tied in a numeric fashion to scores which are earned by the driver. These scores may be generated by the incentive company and based on objective telematic and smartphone usage data. Such telematic data might be acquired through the smartphone and/or a device connected to the car itself.

Each month, the policy-holder, also called the system payer, such as a “parent,” may make a payment into a “Portal” system the entire amount corresponding to the policy without application of any premium reduction.

The full premium amount is paid into the portal every month. Upon earning a discount, determined by the driver's score, the insurance company issues a new lower premium amount. After that month the premium is discounted and the remaining difference between full premium and discount premium is deemed “the incentive” amount. This payment may be subject to a percentage draw which is paid to the incentive company. This payment has an option for the driver to receive it or the payer can opt to take it back themselves.

The parent may also pay a separate fee monthly to the incentive company for services rendered.

The safe driving incentive system may run provide a reward payment after a cycle time, such as at the end of each week or each month. A monitored driver may receive the reward payment into their account based on their driving rating for the cycle time and/or the amount designated by the system payer. A parent may set a maximum reward payment and the full payment may be provided to the monitored driver if their driver rating is above a threshold value, which may also be set by the parent or the insurance company. The reward payment may be reduced for driving metrics that are out of bounds or above thresholds, such as for speeding, or decelerating to rapidly, for example. An algorithm may be used to determine the driver rating and the driver rating may be used to determine the insurance premium. In an exemplary embodiment, the reward payment is the same or some portion of reduced insurance premiums.

In an exemplary embodiment, a full reward may not be paid to the monitored driver due to non-safe driving and a low driver rating, thereby leaving a reward balance. This reward balance may carry over to the next cycle and the driver may be able to recoup this reward balance or a portion thereof if they drive safely and have an increased driver rating or driver rating above some threshold. A reward bank may be a reward balance or balances from previous cycles and the premium balance for the current cycle. A monitored driver may be incentivized to drive safely to recoup lost reward due to prior non-safe driving. Note that the monitored drive may be a child of the system payer or may be the system payer.

The reward payments may be made to the monitored driver periodically, such as on a weekly or monthly basis, and may be based on the driver rating on a preceding time period. The driver rating may be reset at the beginning of each new monitoring period, or may be a continuous running rating that may fluctuate based on the driver's safe driving. For example, the driver may have a reduced driver rating at the end of one monitoring period and may have to demonstrate safe driving, thereby having little to no infractions to bring the driver rating up, and therefore increase the reward payment. The driver rating may be increased by time driving with no infractions. Again, the driver rating may be monitored and displayed in real time to provide real time incentives or may be recalculated after a monitoring period, such as after each driving event, at the end of each day, week or month for example. The reward payment may be a direct correlation with the driver rating, wherein a driver rating of 100% results in a full 100% or maximum reward payment and a driver rating of 50% results in a reward payment of only 50% of the full or maximum reward payment. The reward payment may however be calculated based on ranges of driver ratings and the correlation may be non-linear. For example, a driver rating of 95 to 100% may result in the full payment whereas a driver rating of 90 to 94% results in only 80% of the full payment.

In an exemplary embodiment, the driver rating and driving performance of a monitored driver may be provided to the insurance company and the monitored driver's rating may be used to set the insurance premium.

The incentive company may interface with the insurance company, the financial institution and the system payer and/or monitored driver in an admirative capacity to ensure that the system is working effectively.

Payments made into and out of the system may be made through any conventional means including a check, bank transfer, electronic transfer, application program interface (API), automated clearing house (ACH) payments, and/or third party payment transactions. These payment methods may be used for system payments, premium payments to an insurance company, operation payment, loss-ratio payment and/or a reward payment.

The incentive company may receive the system payment from the system payer and may make reward payments to the payer or to a monitored driver designated by the system payer. An incentive company may partner with a financial institution, such as a bank, and the financial institution may pay the incentive company an operation payment or revenue share for licensing and operation of the safe driving incentive system. The insurance company may provide a loss ratio dividend for the reduction in claims and cost of monitored drivers. A loss ratio dividend payment may be some portion of the reduction in cost of claims by monitored drivers, such as about one-half or more, about one-third or more, about one quarter or more and any range between and including the values provided. This loss ratio payment may be provided to the incentive company and/or to the financial institution.

The incentive company may be a separate company from the insurance company wherein the incentive company operates independently from the insurance company and wherein the incentive company may have no financial obligations to the insurance company.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a diagram of an exemplary safe driving incentive system wherein a system payer makes an incentive payment that is available as a reward payment to a monitored driver for safe driving

FIG. 2 shows a diagram of an exemplary safe driving incentive system wherein a system payer makes a system payment resulting in a premium balance that is available as a reward payment to a monitored driver for safe driving.

FIG. 3 shows a diagram of an exemplary safe driving incentive system.

FIG. 4 shows a diagram of an exemplary safe driving incentive system and a reward bank made up of a premium balance and a reward balance.

FIG. 5 shows an exemplary system App display on a mobile phone showing the reward bank value, the reward earned value and the reward potential value as well as the insurance premium, the premium discount potential, premium discount earned and the remaining premium discount potential.

FIG. 6 shows a monitored driver driving a monitored vehicle and the exemplary safe driving incentive system monitoring the vehicles location, speed and acceleration through the monitoring system.

FIG. 7 shows a diagram of an exemplary safe driving incentive system wherein system payments are received by a financial institution and wherein reward payments are made to the monitored driver.

FIG. 8 shows a mobile phone running a driving incentive system App that provides alerts and warnings and the driver's current driver rating and reward amount.

FIG. 9 shows a mobile phone running a safe driving incentive system App that operates while the driver is driving to deter them from texting while driving.

FIG. 10 shows a mobile phone running a safe driving incentive system App that disables texting functions while the monitored driver is driving.

FIG. 11 shows mobile phone running a safe driving incentive system App with an administrator function to select and delete driving events from the driving event log.

FIG. 12 shows a mobile phone running a safe driving incentive system App that requests confirmation of a driving event or confirmation of a passenger event.

FIG. 13 shows a mobile phone running a provisionally-licensed driver App that provides a training drive confirmation and a map display of a potential training drive.

FIG. 14 shows a mobile phone running a provisionally-licensed driver App with an administrator function to select and delete driving events from the provisionally-licensed driving event log.

FIG. 15 shows a diagram that depicts a mobile device, such as a cellphone, which may be connected to a vehicle's sensor systems, transmitting data to our cloud-based server.

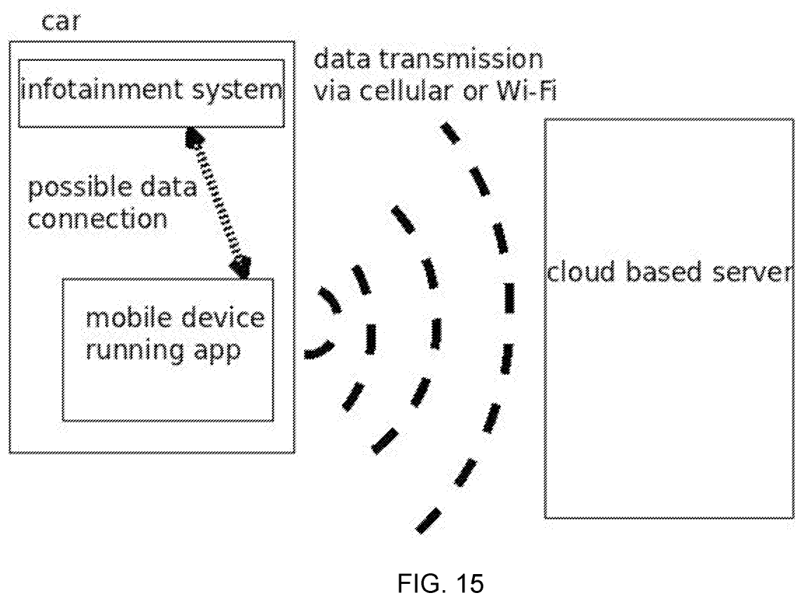

FIG. 16 shows a diagram that depicts two smart phones or devices simultaneously transmitting to our cloud-based server. A record of both trips which matches sufficiently in parameters will create a “simultaneous trip event.”

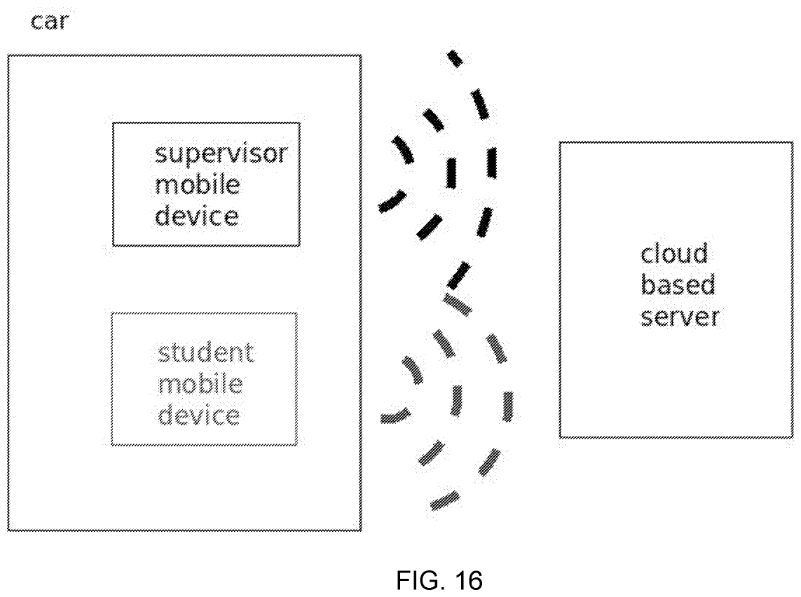

FIG. 17 shows a diagram that depicts sets of trips—by both students and supervisors—and shows an algorithm which cross references the trips and searches for matching location service data; which then verifies and links the trips showing simultaneous drives for student and supervisor.

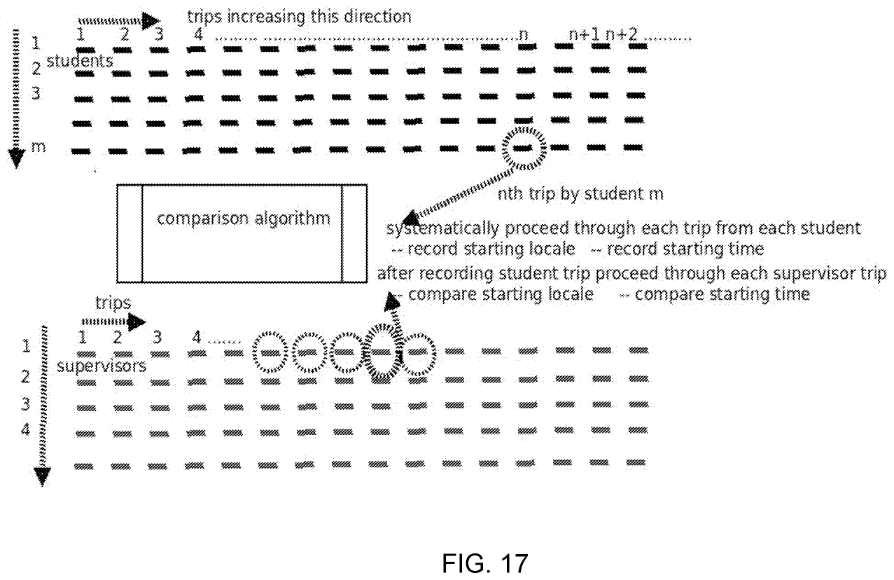

FIG. 18 shows a diagram that depicts the conclusion of such a search where a matching supervisor/student trip has been located. These are now marked as simultaneous trips and are ready to be recorded in the student's digital log.

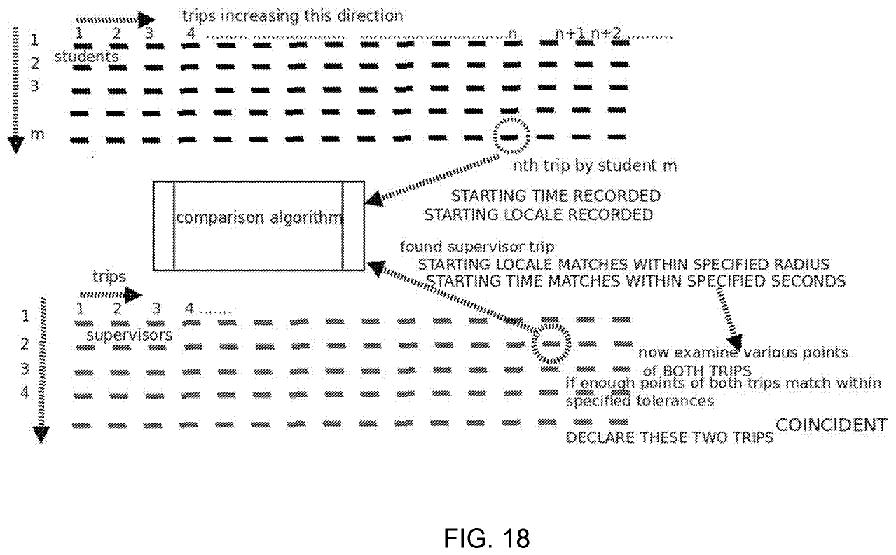

FIG. 19 shows a diagram that depicts the most primitive possible version of the system App of the safe driving incentive system. This illustrates the single incentive model which includes a telematics driving score being used as the basis to calculate the disbursement and release of the parental incentive payments.

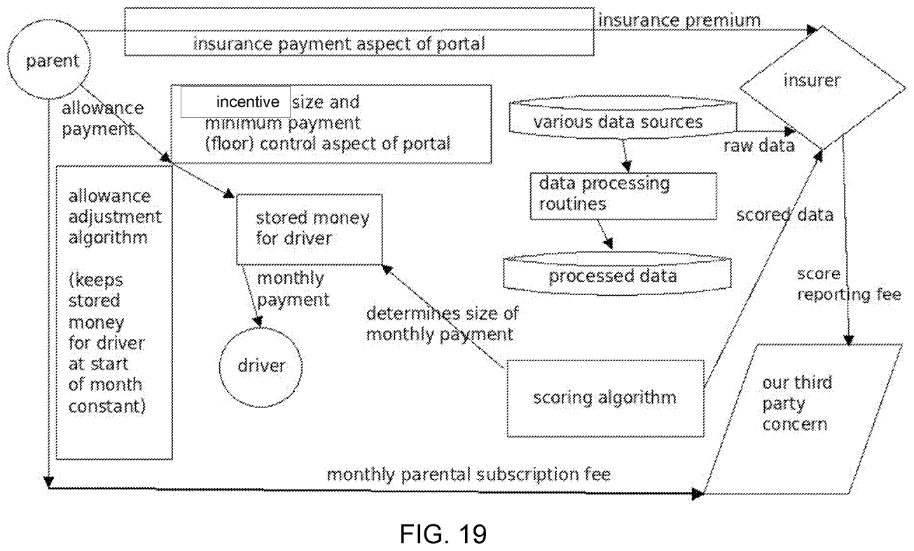

FIG. 20 shows a diagram that depicts the second mode of the rewards system where discounts from the insurer have been turned into incentives and have been combined with the parental incentive payment funds.

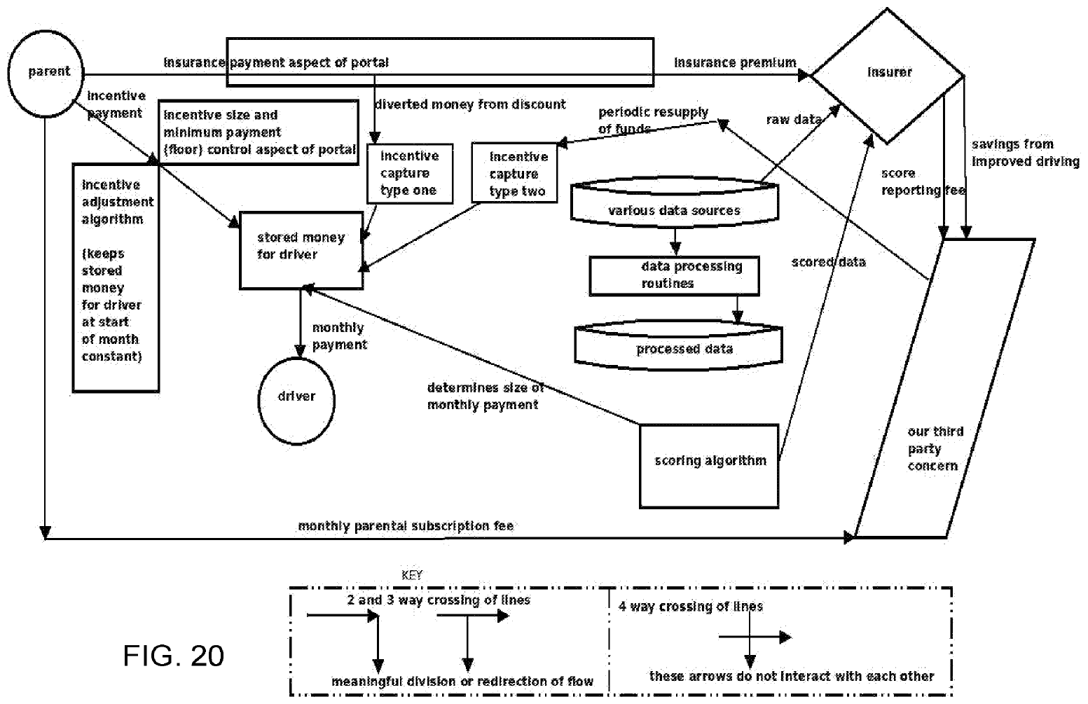

FIG. 21 shows a diagram that depicts the same process as FIG. 19 but in this example the incentive funds are channeled from a 3^{rd} party independent finance company or funding partner which funds the incentive program independently.

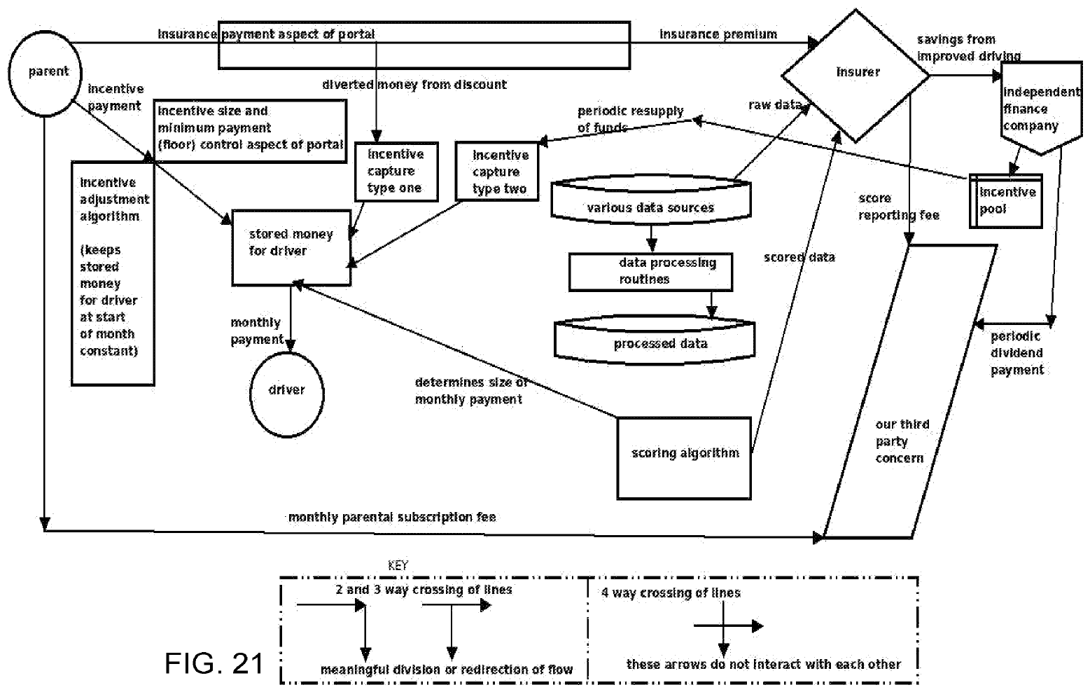

FIG. 22 shows a diagram that depicts a “Complete Overview of Entire Rewards App Logical Schematic Description.” This is a diagram that depicts the flow of information between seven subsidiary schematics (the seven following Figures) which comprise the algorithm. Each alphabetically labeled arrow on this figure corresponds to an arrow labeled “schematic arrow {X}” (where {X} is an alphabetic character) on the following seven diagrams. Some elements (H, F, and M) that properly belong to only two of the seven smaller schematics are actually displayed on three of the seven subsidiary schematics.

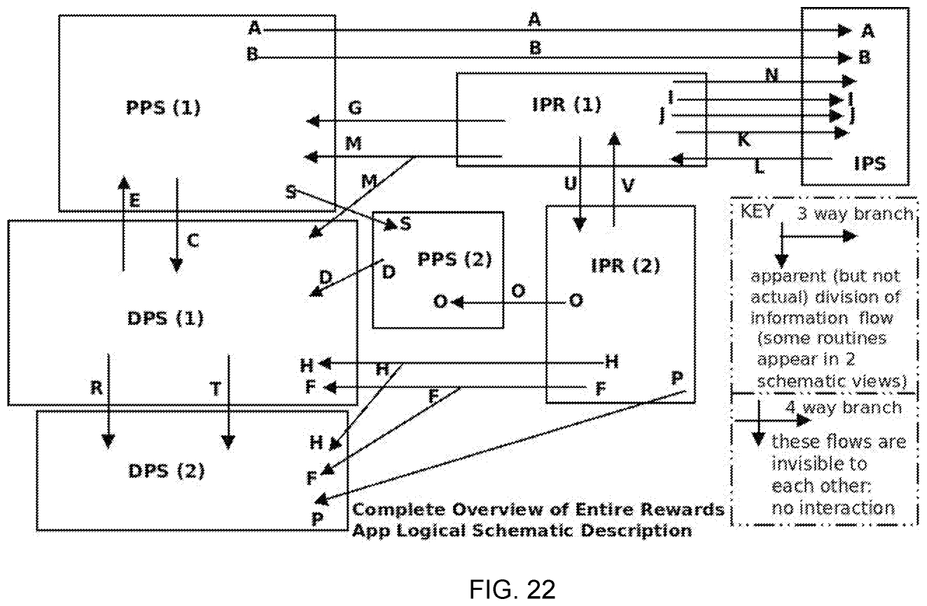

FIG. 23 shows a diagram of a “Parental Payment System (part one) (PPS) Schematic.” (PPS (1)) is a diagram that depicts how the payer interacts with the rewards system. Five arrows radiating from the “parent” show the five possible facets of financial interaction within the system. Schematic arrow S describes the connection to “Parental Payment System (part two) (PPS) Schematic.” The “incentives bank” (connected to IPR (1) by arrow M) is actually part of DPS (1) but is displayed here for redundancy and ease of illustration of the continuity of the system.

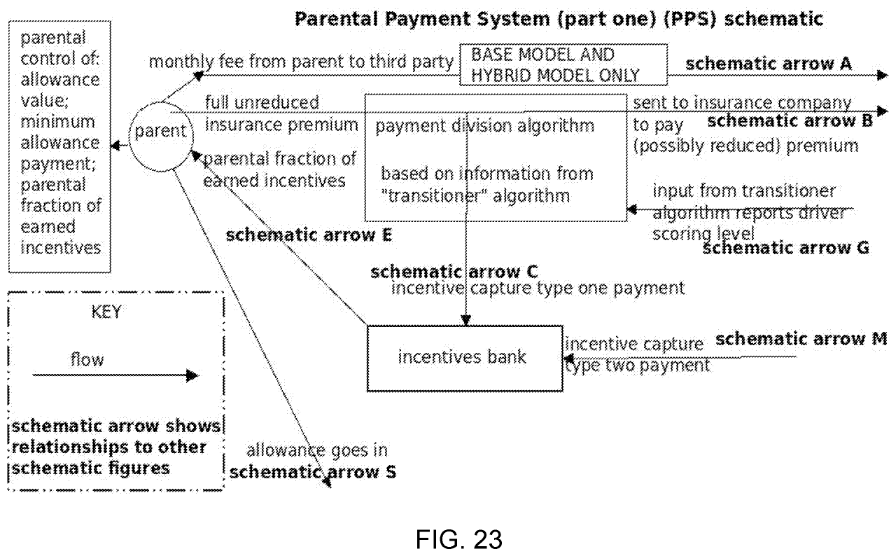

FIG. 24 shows a diagram of a “Parental Payment System (part two) (PPS) Schematic.” PPS (2)) is a diagram that depicts how the payer interacts passively with the rewards system. This figure is a diagram that depicts how information (arrow O) allowing the parent to monitor the performance of the driver is integrated into the system.

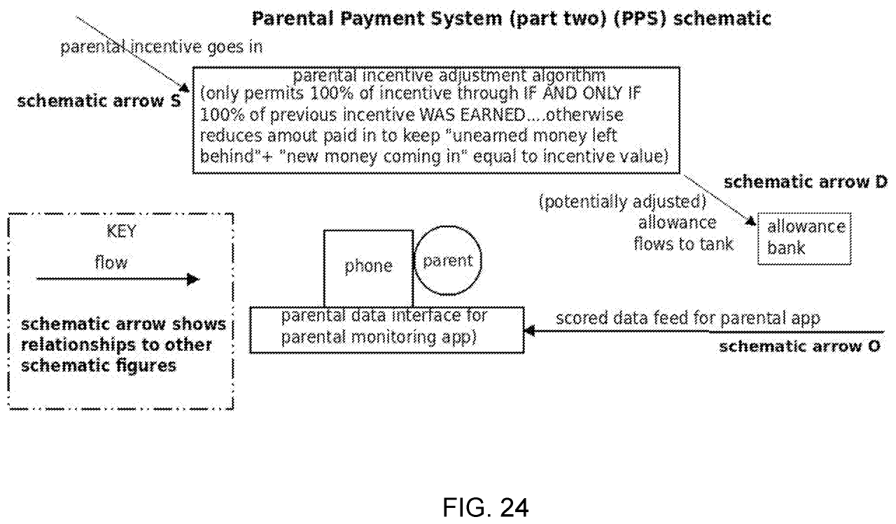

FIG. 25 shows a diagram of a “Driver Payment System (part one) (DPS) Schematic.” DPS (1)) is a diagram that depicts the connection to PPS (1) by means of schematic arrows E and C and illustrates the connection to PPS (2) by means of schematic arrow D. The “payout system” (connected to IPR(2) by arrows H and F) is actually part of DPS (2) but is displayed here for redundancy and ease of illustration of the continuity of the system.

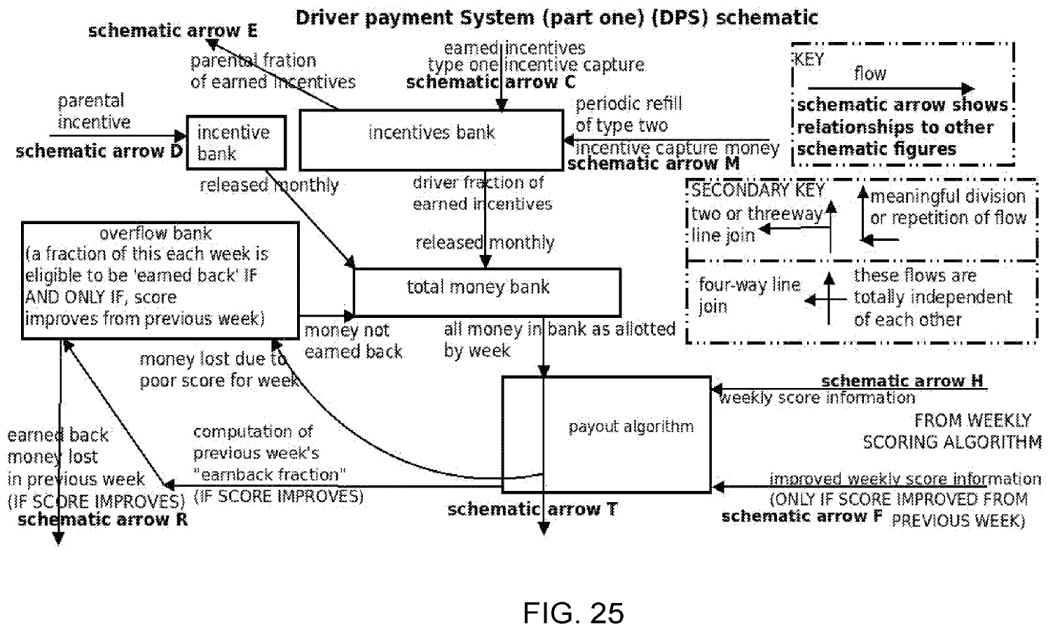

FIG. 26 shows a diagram of a “Driver Payment System (part two) (DPS) Schematic.” DPS (2) is a diagram that depicts the interaction of the system with the driver. Funding (coming from DPS (1)) is illustrated by arrows R and T from DPS (1) while scoring information (from IPR (2)) is illustrated by arrows H, P, and F.

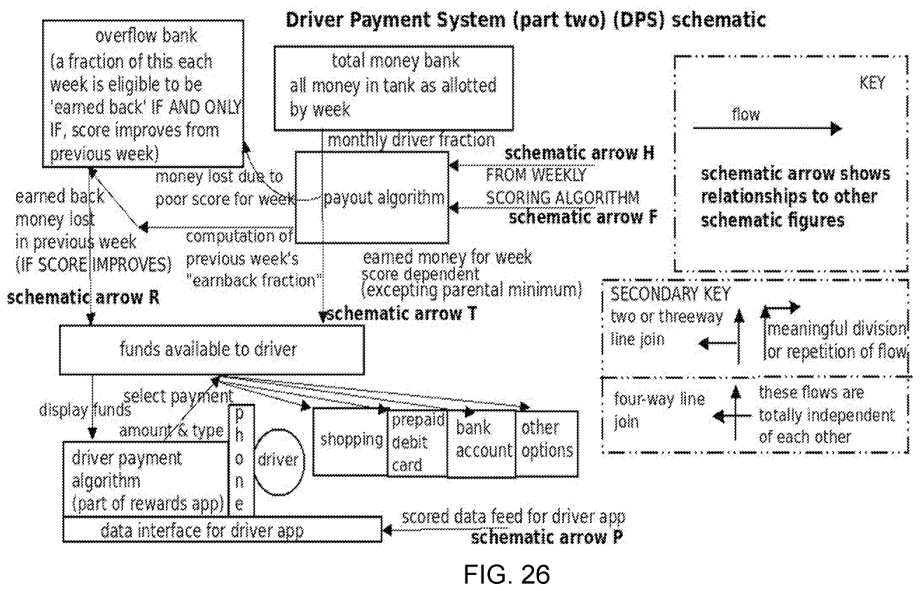

FIG. 27 shows a diagram of a “Information Processing Routines (part one) (IPR) Schematic.” IPR (1)) is a diagram that depicts how information (arrow G) and funding (arrow M) are connected to PPS (1). Schematic arrows U and V and depicts connections to IPR (2) while arrows N, I, J, and K show information flowing to IPS. L Is a diagram that depicts funding moving in from IPS. All raw system data from the vehicle systems and mobile device systems (trips) originates here.

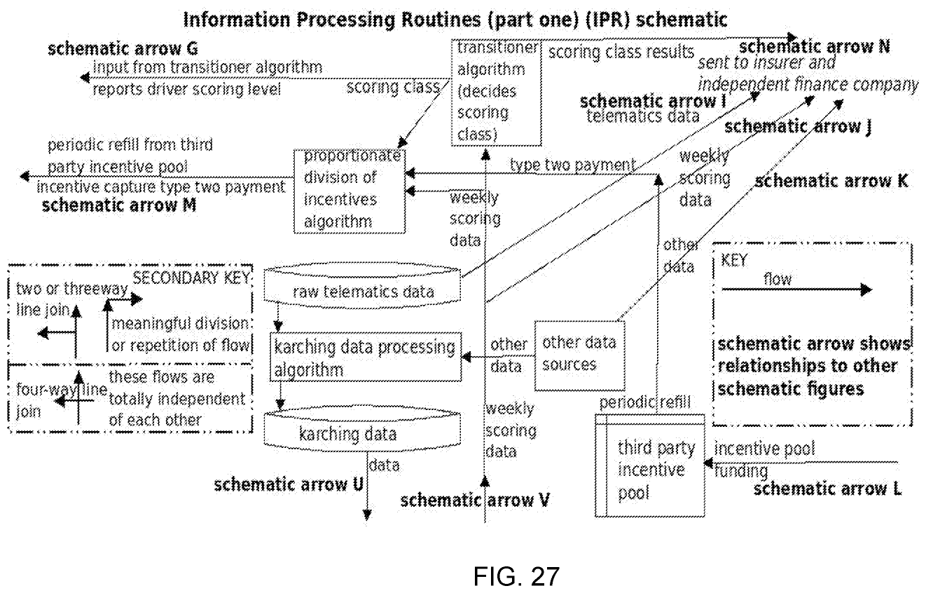

FIG. 28 shows a diagram of a “Information Processing Routines (part two) (IPR) Schematic.” IPR (2)) is a diagram that depicts connections P and O which feed driver information and parental score monitoring information to DPS (2) and PPS(2) respectively. Scoring information is sent by H and F to DPS (2).

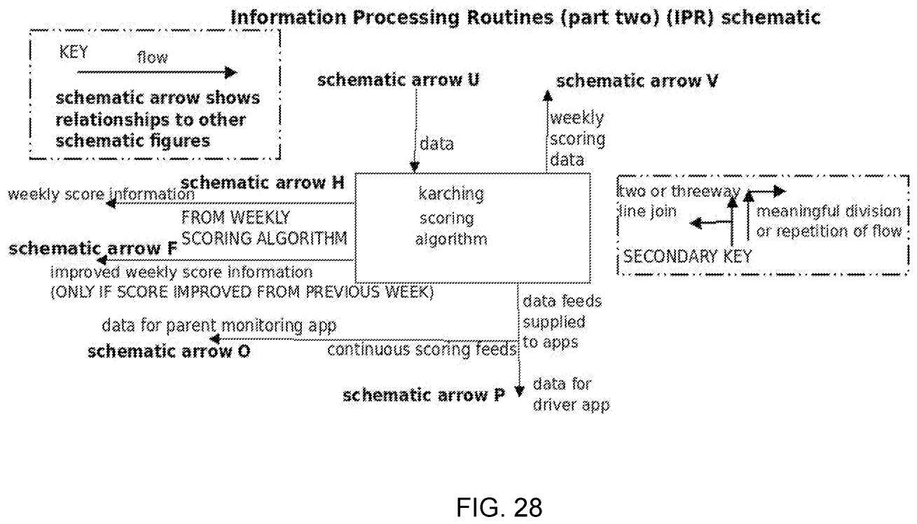

FIG. 29 shows a diagram of a “Insurance Payment System” is a diagram that depicts the receipt of funding from PPS (1) (arrows A and B) and transmits funding to IPR (1) (arrow L). Arrows N, I, J, and K represent information incoming from IPR (1).

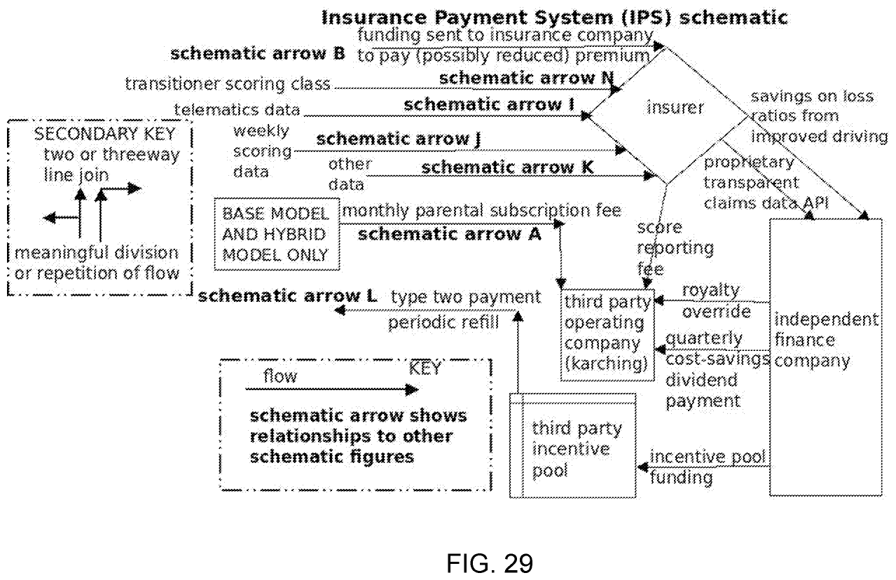

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

A reward payment for safe driving to a monitored driver may include a premium balance, a reward balance, or a leftover portion of a reward bank from a previous cycle and an incentive payment, a payment made into the system to further incentivize the monitored driver to drive safely. The premium balance will depend on the cost of the premium. The cost of the premium may go down or be discounted due to the driver driving safely. Therefore, from one cycle to another, the premium balance may change according to the driver rating. A driver may be monitored via a monitoring system and a driver rating may be determined. The amount of the premium discount may be determined through the driver rating. In addition, the amount of the reward payment may be determined by the driver rating. A monitoring system may utilize a location services system to determine the location, speed and acceleration of the vehicle and this data, such as Telematics data, may be transmitted to a database in real time. For example, a driver may drive safely and achieve a driver rating above a value required to receive the full premium discount and therefore may increase their reward payment.

In an exemplary embodiment, an incentive company may arrange with the insurer a policy with a monthly payment and variable policy premiums. The amount of reward payment will be adjusted per cycle, such as monthly, in accordance with data collected by the incentive company and shared with the insurer. The adjustment will accord with certain scoring thresholds, that are agreed upon with the insurer, which are generated by the incentive company and based on monitoring system and driver rating.

Each cycle period, the policy-holder, such as a parent, will pay into the safe driving incentive system the entire amount corresponding to the policy without application of any reward payment. The full premium amount is paid into the system every cycle, again such as every month. Upon earning a discount determined by the drivers rating, the insurance company issues a new lower premium amount. Each month the premium is discounted and the remaining difference between full premium and discounted premium, or premium balance is determined. The value contained in the reward bank is made available for the driver to receive as a reward payment, or the parent can opt to take some portion back themselves. The amount of reward payment will be adjusted monthly in accordance with data collected by the monitoring system.

Each cycle, the system payer, such as a parent may also pay into the safe driving incentive system an incentive payment, which will be added to the reward bank and made available to the monitored driver as an additional incentive to drive safely. A reward payment algorithm may be run to determine how much a reward payment will be for a give cycle, such as every week or every month. If the driver achieves a very high driver rating, thereby indicating safe driving, the full reward bank may be provided to the monitored driver. In addition, if the monitored driver maintains a high driver rating, the insurance premium may be reduced, thereby increasing the premium balance and the reward bank for subsequent cycles. A parent or system payer may have the ability to determine the amount of the reward that is paid to the monitored driver or they may simply let the reward payment be determined through the reward payment algorithm. The system payer can also include an incentive payment to further incentivize the monitored driver to drive safely.

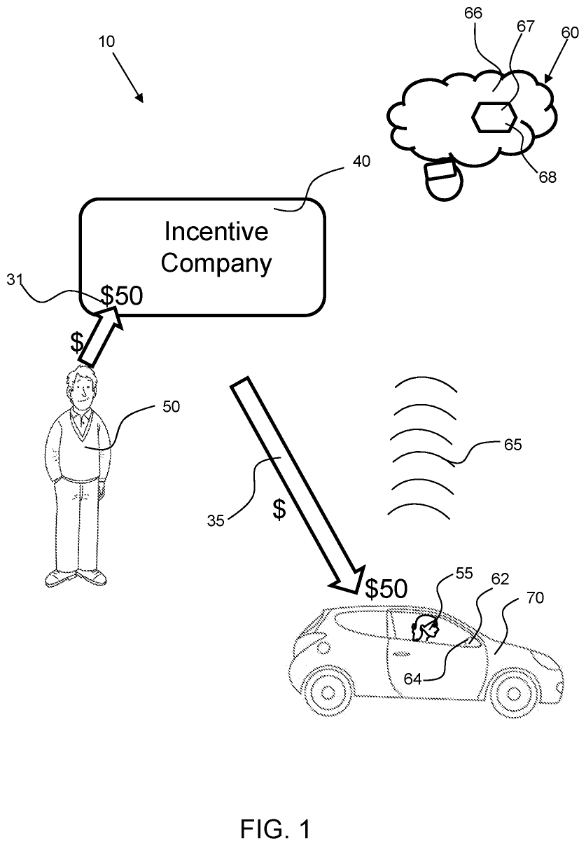

As shown in FIG. 1, an exemplary safe driving incentive system 10 utilizes an incentive company 40 that collects an incentive payment 31 that is available as a reward payment 35 to a monitored driver 55 for safe driving. The monitoring system 60 utilizes a location services system 62 to determine the location, speed and acceleration of the vehicle 70. A wireless transmitter 64, such as within the vehicle or as part of a mobile phone or On-board diagnostic (OBD) device may send a wireless signal 65 to a database 66 of the monitoring system 60. A computer 67 may run an algorithm 68 or computer program to determine a driver rating. This driver rating may be reduced by speeding above a posted speed limit, accelerating above an acceleration threshold value, decelerating above a decelerating threshold value, or hard turning above a turning acceleration threshold value. In some cases, the monitoring system receives input from a vehicle monitoring system that utilizes cameras to determine a position of the vehicle with respect to lanes or a forward vehicle. If the vehicle veers out of a roadway lane too often the driver rating may be reduced, or if the monitored vehicle tailgates for too long during a driving event, the driver rating may be reduced. The computer 67 may run a reward payment algorithm to determine a reward payment based on the driver rating. The reward payment may be the full incentive amount of $50 if the driver rating is above a threshold value.

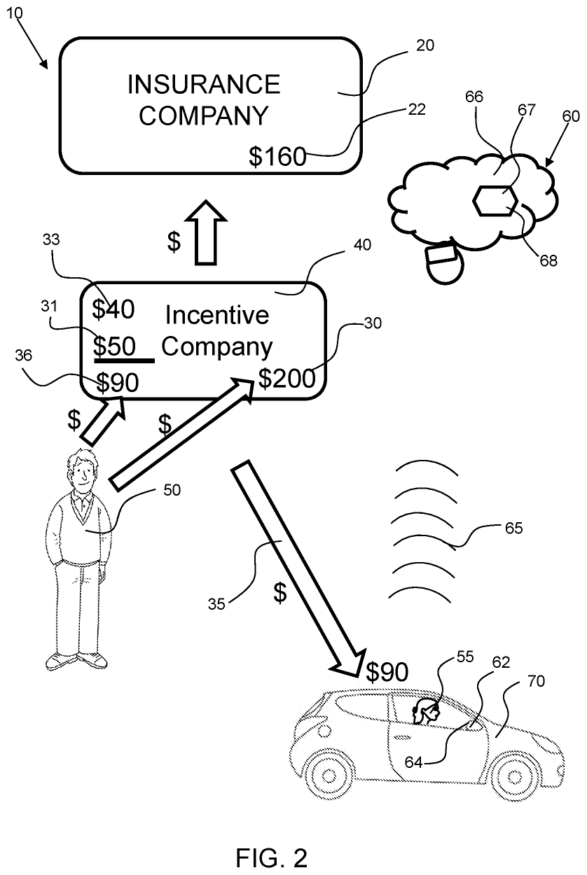

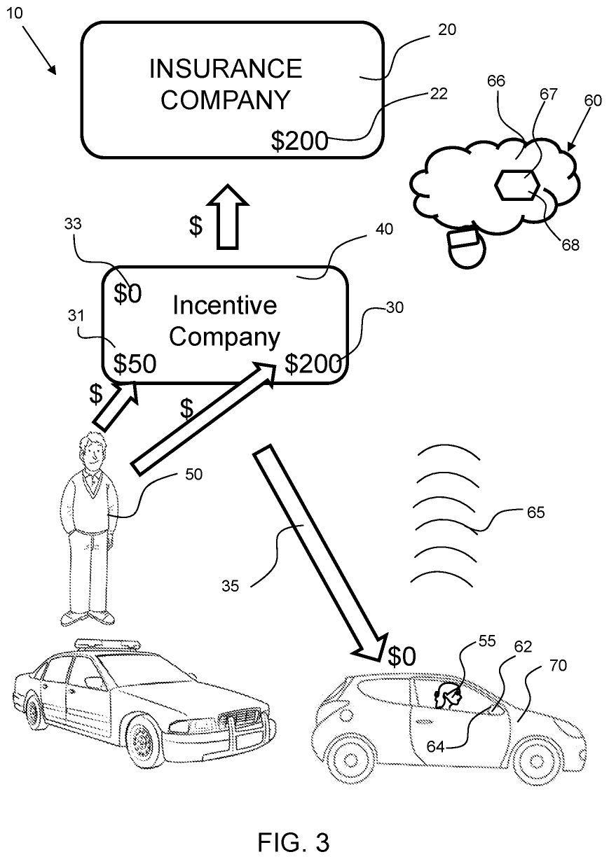

As shown in FIGS. 2 and 3, an exemplary safe driving incentive system 10 utilizes an incentive company 40 that collects a system payment 30 and pays the insurance company 20 an insurance premium 22 from this system payment. The system payment is greater than the insurance premium required therefore leaving a premium balance 33 of $40 as shown in FIG. 1, which is an amount that may be paid to a monitored driver 55 as a reward payment 35 for safe driving, or reclaimed by the payer 50. As shown, the payer 50, such as a parent, pays the $200 system payment 30 and may also provide an incentive payment 31 of $50 which may further incentivize the monitored driver to drive safely. This personal incentive payment may be combined with the premium balance to produce a reward bank 36 of $90, or the sum of these two amounts which may be paid to the monitored driver if they exceed a driver rating threshold value. As shown in FIG. 1, the system payment is $200 and the current insurance premium 22 is only $160 thereby leaving $40 as an incentive that may be paid to the parent 50 or to the monitored driver 55, such as a child of the parent, for safe driving of the vehicle 70. Insurance companies are not currently allowed to provide a direct rebate for safe driving and the intermediate incentive company enables this system to operate effectively and legally. In addition, the computer may run an algorithm to determine a premium discount based on the driver rating. This premium discount may further increase the premium balance that is available as a reward payment and therefore further incentivize the monitored driver to drive safely.

As shown in FIG. 3, the insurance premium has been increased due to the monitored driver speeding and receiving a speeding ticket. Therefore, there is no premium balance 33, available as a reward payment to the monitored driver 55. The parent may choose to continue to pay an incentive payment 31 to encourage the monitored driver to drive safely. The system payer or parent may determine how much of the incentive payment to pay the monitored driver 55 as a reward payment 35 after each cycle. Note that the incentive payment may be considered an allowance for the monitored driver.

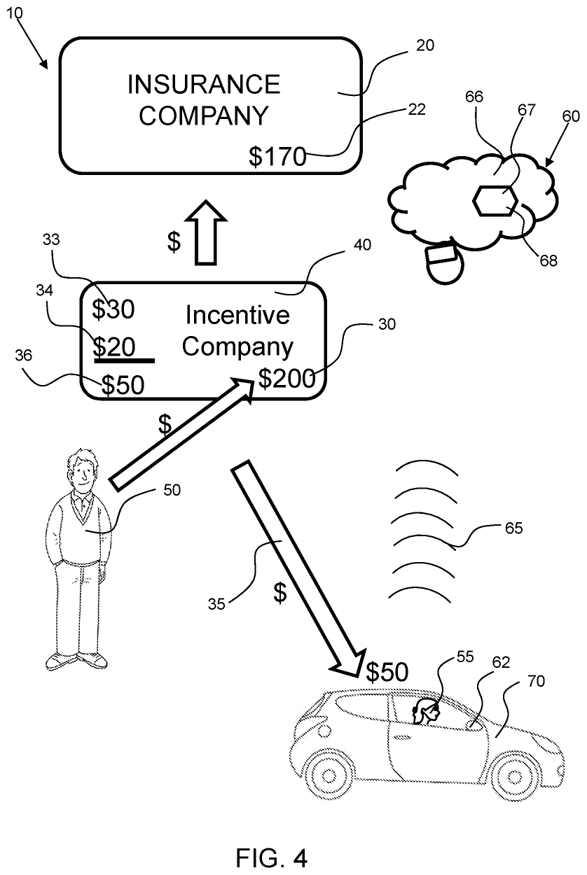

As shown in FIG. 4, there is a premium balance 33 of $30, as the system payment is $200 and the insurance premium is $170. The insurance premium may be increase due to the monitored driver having a low driver rating. There is also a reward balance 34 of $20 from a previous period. The reward bank 36 of $50 is the sum of the reward balance and the premium balance. The reward bank or a portion thereof may be available as a reward payment 35. Again, the system payer may also provide an incentive payment to further incentivize the monitored driver to drive safely.

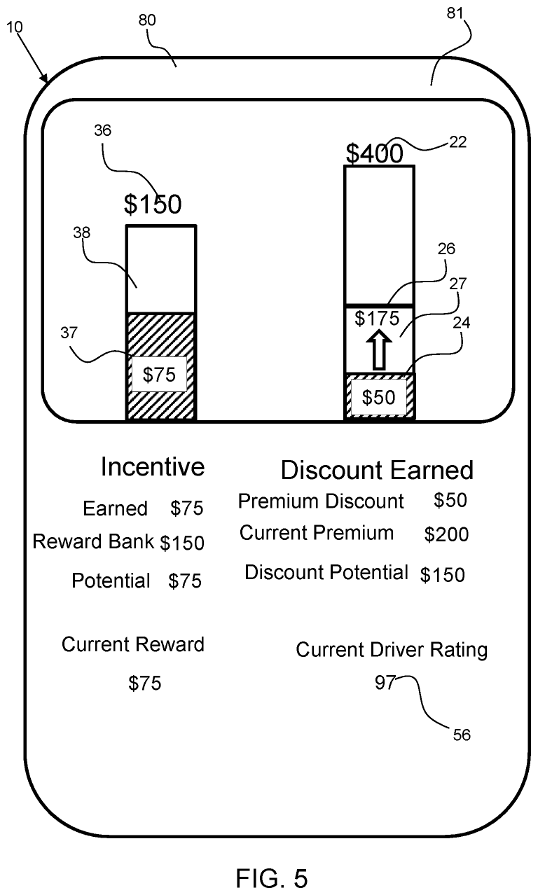

FIG. 5 shows a display of a system App 81 on a mobile phone 80 showing the reward bank value 36 of $150 and a reward earned value 37 of $75, thereby leaving a reward potential value 38 of $75. If the monitored driver continues to drive safely for the remainder of the cycle, they may earn the full reward bank value of $150. This provides the incentive to drive safely. The right bar graph shows the insurance premium 22 of $400, the premium discount potential 26 of $175 along with the current premium discount earned 24 of $50 for the cycle period. The monitored driver may obtain the remaining premium discount potential 27 of $125 to reach the full premium discount potential of $175 if they maintain a high driver rating 56, as shown. A driver rating may be a based on 100 being a highest safe driver rating and 0 being the lowest driver rating.

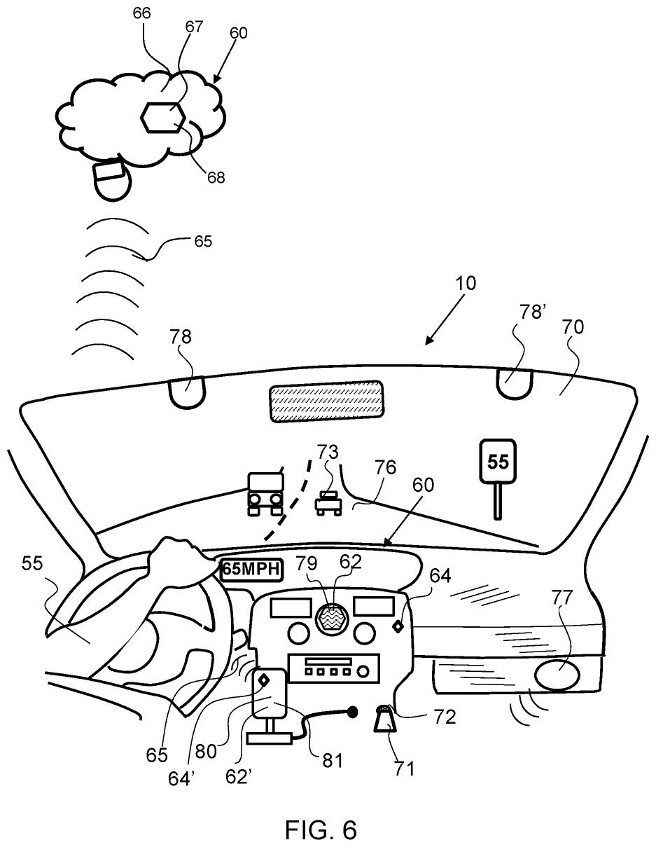

As shown in FIG. 6, a monitored driver 55 is driving a monitored vehicle 70. The monitoring system 60 is monitoring driving metrics including vehicle location, speed and acceleration such as through Telematics. The monitoring system may utilize a system App 81 configured on a mobile phone 80 and the mobile phone may send a wireless signal 65, using a wireless transmitter 64′, to the database 66. The mobile phone may have a location services system 62′, such a global positioning system, for determining driving metrics. The monitoring system may utilize a location services system 62 that is part of the vehicle 70 and the vehicle may have a wireless transmitter 64 for sending driving metrics to the database. Also, a mobile device such as a mobile phone may interface with the vehicle, such as through a wireless signal or Bluetooth connection or through a plug that is plugged into the vehicle as shown. Finally, a monitoring system may utilize an On-board diagnostic (OBD) device 71 which may be plugged into an OBD port 72. A vehicle location services system 62 or the OBD device may transmit driving metrics to the database and may interface with the vehicle vision system 79 to receive lane departure and tailgating data. An exemplary vision system 79 utilizes one or more cameras 78, 78′ to monitor the location of the monitored vehicle with respect to the lane 76 and with respect to a forward object, such as a forward vehicle 73.

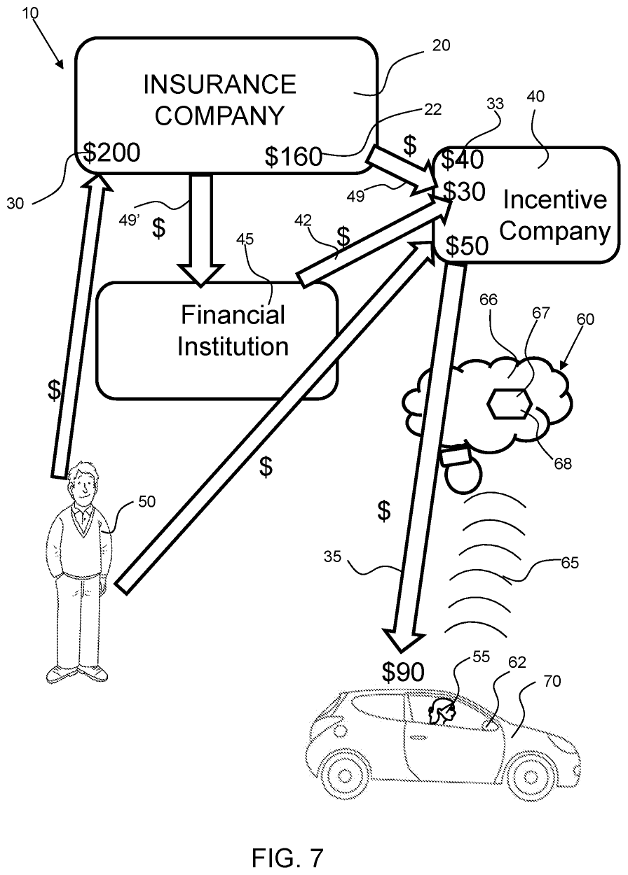

As shown in FIG. 7, an exemplary safe driving incentive system 10 includes a financial institution 45, such as a bank, that may provide operation payments 42, $30, to the incentive company for operation of the system in return for a portion of a loss ratio dividend 49′ which is a payment made by the insurance company for a reduction in the number of cost of claims by monitored drivers. The incentive company may dramatically reduce the cost of claims from monitored drivers and the insurance company may pay the insurance company or other parties, such as the financial institution a portion of these savings, a loss ratio dividend. Note that the loss ratio dividend 49 may be paid to incentive company and the incentive company may then provide a portion of this payment to the financial institution. The incentive company 40 interfaces with the insurance company, the system payer and the financial institution to ensure that system is working effectively. The incentive company may operate and maintain the system app, for example, and may make the reward payments 35 to the monitored driver 55. Note that the system payer 50 in this embodiment may make the system payment 30 directly to the insurance company 20. Also, the reward payment may be made by the incentive company or the financial institution.

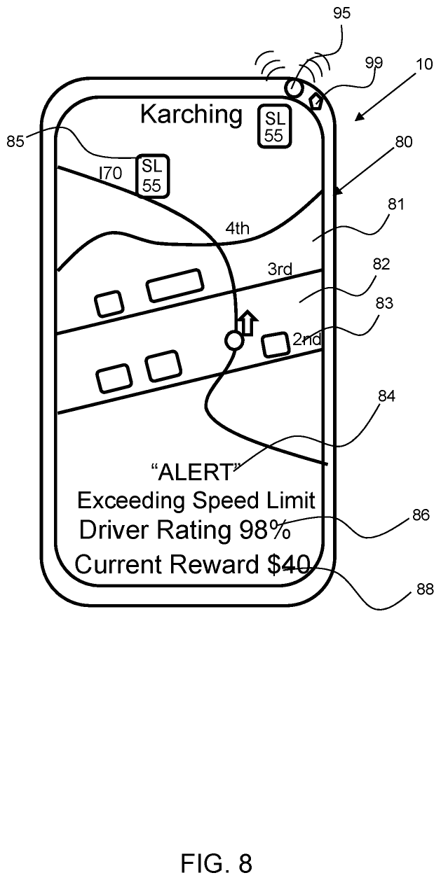

As shown in FIG. 8, an exemplary safe driving incentive system 10 comprises a system App 81 that runs on a mobile phone 80 while the driver is driving and may provide alerts if unsafe driving is detected, such as speeding, or talking or texting while driving. As shown, the system App displays a map 83 on the display screen 82 and the posted speed limit 85. If the driver exceeds the posted speed limit, a speeding alert 84 may be activated and produce an alarm 87 produced through the speaker 95 of the mobile phone 80. The driver's rating 86 may be posted and this driver rating may be used to determine the amount of a reward payment. For example, a driver rating of 90% or above may elicit the full reward payment and a driver rating of 80% to 90% may result in a payment of only 80% of the reward payment. The driver rating may also be tied directly to the amount of reward payment, whereby the driver rating, 0 to 100%, is the percent of the reward payment the driver will receiver. The current reward payment 88 may also be displayed on the system app. The posted speed limit may be determined through a global positioning system 99, that interfaces with the mapping software to determine the speed limit for a given roadway.

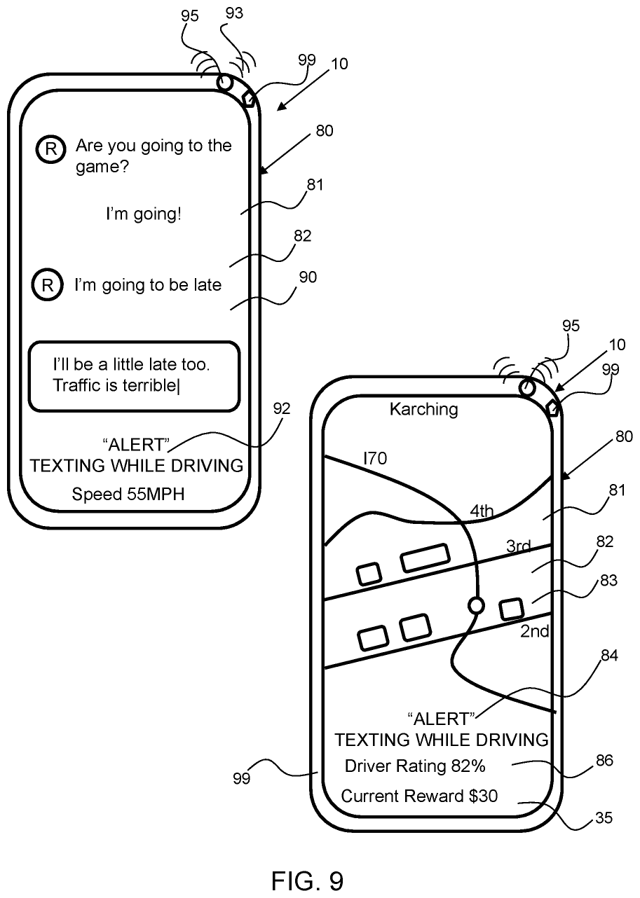

As shown in FIG. 9, the system App 81 may run in the background and may detect if the driver is talking on the phone or texting while driving. As shown, the driver has opened the texting App 90 and is texting a friend about going to a game. The system App 81 produces a texting alert 92 that may produce a printed texting alert 92 on the display screen 82 and/or an audible alert 93 produce by the mobile phone speaker 95. When the driver returns to the map with the system App running in the foreground, the drivers rating and current reward payment may be updated to show the reduction in reward payment amount as a result of texting while driving. As describe herein, there may be a threshold speed limit, 5 MPH or less, that will not cause the system to produce a texting alert or alarm, as the driver may text while parked or at a stop light, for example. The same alert system and reward payment reduction may function when the driver is speaking on the phone without hand's free communication with the vehicle.

The system App may detect if the mobile phone is connected via Bluetooth to the vehicle and may disregard phone call when this safe form of communication is utilized.

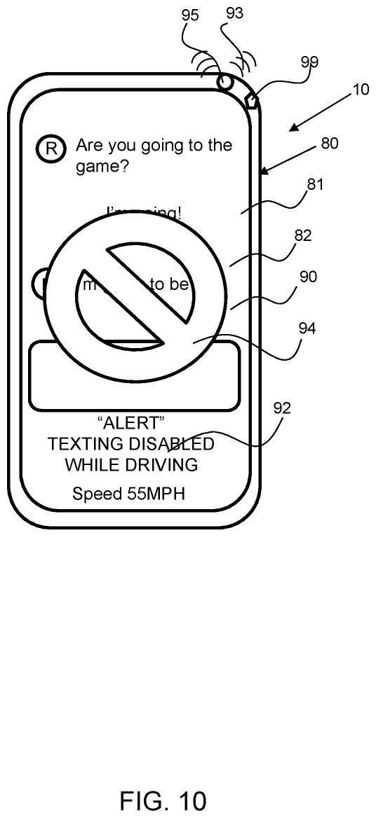

As shown in FIG. 10, texting or certain functions of the texting App may be disabled while driving. For example, a texting disabled alert 94 may be posted to prevent the user from texting when the vehicle is in motion, such as greater than 5 MPH. In addition, the entire texting App may not open while the vehicle is in motion, thereby preventing the driver from reading texts while driving. Furthermore, certain texting App functions may be disable while driving, such as the audible notice, “bling,” that accompanies and incoming text. This may ensure that the driver is not tempted to pick up and view the text while driving.

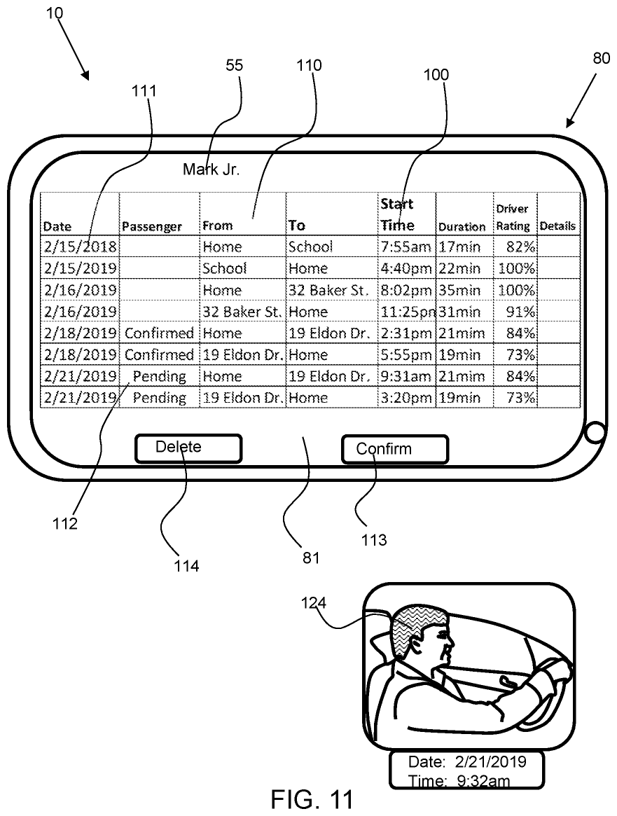

As shown in FIG. 11, an exemplary safe driving incentive system App 81 comprises an administrator subroutine 100 that may be accessed by a system payer, such as a parent, to view driving events of a monitored driver 55, Mark Jr. The administrator may view the driving event log 110 of one or more monitored drivers, such as one or more of their children. The driving event log 110 has a list of driving events 111 that includes the date, start, or beginning location, as well as destination or final location, the start time, the duration of the driving event and the driver rating for that particular driving event. The administrator may click on details to see a map and the route the vehicle took during the driving event and may see the speeds along the driving route. The map may indicate locations of speeding, whereby the roadway is highlighted in red where a driver was speeding, for example. In addition, in the details, the administrator may see any incidents of using a mobile device while driving. Note that a driving log may also be available to a monitored driver on their safe driving incentive system app. An administrator may however have the ability to select and remove driving events from the driving log. If the monitored driver was a passenger, but the system logged the event as a driving event, the administrator may be able to select a driving event for deletion. There may be an indication or display on the driving event log that monitored driver was a passenger for that event. The monitored drive may select passenger when prompted by the system App and may take a photograph of the driver that is stored by the system. The administrator may select a pending passenger event, views the details of the event, including a photograph of the driver, as shown below, and then confirm it was a passenger event using the passenger confirmation feature 113. Confirmed passenger events will not be used in the calculation of the driver rating. An administrator may delete confirmed passenger events and/or driving events. As shown, the selected driving event 112, can be deleted using the driving event deletion button 114.

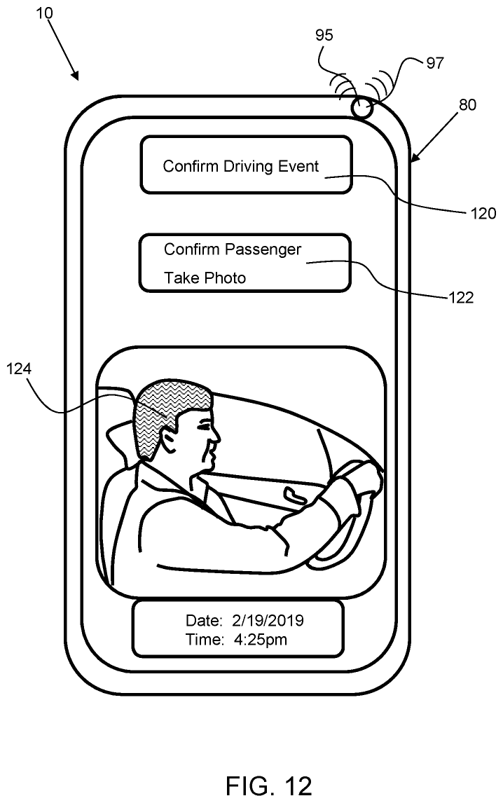

As shown in FIG. 12, an exemplary safe driving incentive system App 81 comprises a driving event confirmation feature 120, that may automatically pop up on the monitored driver's mobile phone when the system detects that the monitored driver is moving above a threshold speed, such as 10 mph or more, as described herein. The monitored drive may click on the confirm button to confirm that they are driving and that the system should log the driving event. If, however, the monitored driver is a passenger, the system may have a passenger confirmation button 122 and may request that the driver confirms that they are a passenger by taking a photo of the driver. An exemplary passenger confirmation photo feature 124 enables the monitored driver to take a photograph with their mobile phone of the driver of the vehicle. The photograph may be stored with a date and time stamp and this detail may be provided in a driving event log that requires the administrator to accept the driving event.

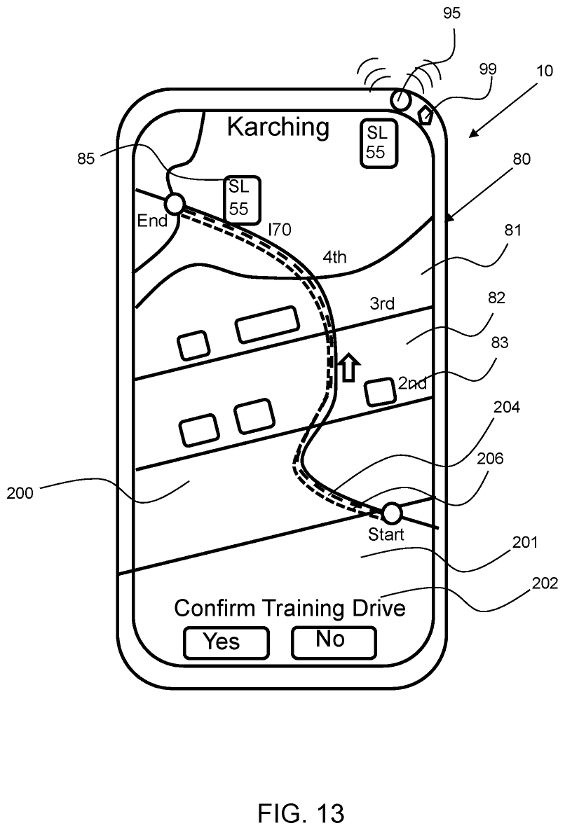

FIG. 13 shows a mobile phone 80 running a provisionally-licensed driver App 200 that has training drive confirmation feature 281 and a training drive map display 201 of a potential training drive. The provisionally-licensed driver's route 204 and the licensed driver's route 206 are shown from a start to an end location. The provisionally-licensed driver or the supervisor licensed driver may confirm the training trip.

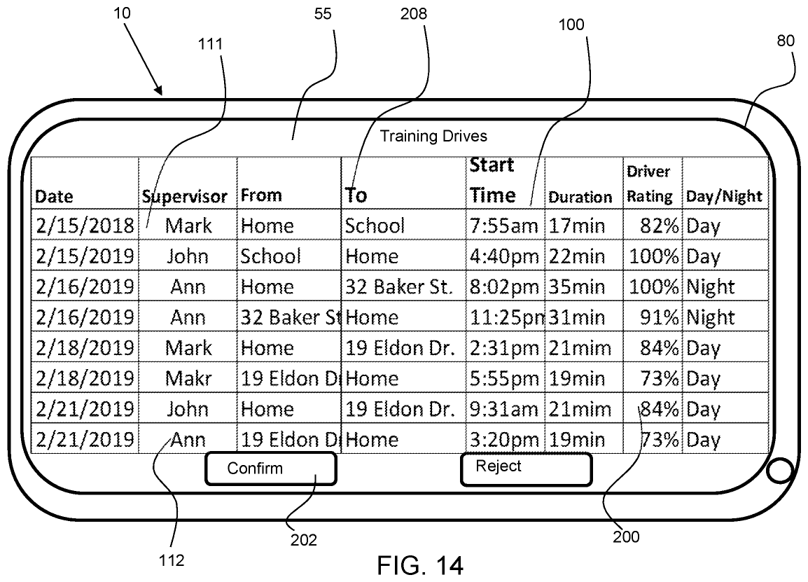

FIG. 14 shows a mobile phone 80 running a provisionally-licensed driver App 200 with an administrator function to select and delete driving events from the provisionally-licensed driving event log. As shown the provisionally-licensed driver drive event log 208 provides dates and times of provisionally-licensed driver training trips and confirmed trips. The administrator has selected a selected driving event 112 from the log and may then use the training drive confirmation feature 202 to confirm or reject the event as a training drive or trip. Each of the driving events 11 on the log may have information about the event such as start and end locations, time of day, driver rating, day or night event, and the like. The monitored driver 55 is the provisionally-licensed driver in this case. As described herein, the provisionally-licensed driver may have to reach a driver rating above some threshold and have enough driving time or miles to qualify for a license.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A safe driving incentive system comprising:
a) an insurance company;
b) an incentive company that is separate from the insurance company;
c) a system payment from a system payer;
d) a monitoring system that monitors driving metrics including location, speed and acceleration of a vehicle operated by a monitored driver;
wherein the monitoring system comprises:
i) a location services system for determining the location of said vehicle;
ii) a wireless transmitter for sending driving metrics to a database;
wherein a reward payment is paid to said monitored driver for safe driving.

2. The safe driving incentive system of claim 1, wherein at least a portion of the system payment is paid to the insurance company for an insurance premium of the system payer.

3. The safe driving incentive system of claim 1, wherein the location services system utilizes a mobile phone located in the vehicle for monitoring driving metrics.

4. The safe driving incentive system of claim 3, wherein the location services system utilizes a global positioning system of the mobile phone.

5. The safe driving incentive system of claim 1, wherein the location services system in configured with the vehicle.

6. The safe driving incentive system of claim 5 wherein the location s utilizes a global positioning system of the vehicle.

7. The safe driving incentive system of claims 3 to 6, wherein the monitoring system detects a driving speed and wherein said driving speed is compared with a posted speed limit based on a location of the vehicle to determine if the monitored driver is speeding.

8. The safe driving incentive system of claim 7, wherein an incident of speeding reduces the driver rating.

9. The safe driving incentive system of claims 3 to 6, wherein an incident of acceleration above an acceleration threshold value reduces the driver rating.

10. The safe driving incentive system of claims 3 to 6, wherein an incident of deceleration above a deceleration threshold value reduces the driver rating.

11. The safe driving incentive system of claims 3 to 6, wherein an incident of hard turning acceleration above a turning acceleration threshold value reduces the driver rating.

12. The safe driving incentive system of claim 1, wherein the location services system in configured with the vehicle and wherein the vehicle has a vehicle location services system that determines the monitored vehicles position.

13. The safe driving incentive system of claim 12, wherein the vehicle location services system utilizes one or more cameras to determine a position of said vehicle.

14. The safe driving incentive system of claim 12, wherein the vehicle location services system determines the monitored vehicles position with respect to a roadway lane and wherein an incident of veering out of a roadway lane reduces the driver rating.

15. The safe driving incentive system of claim 1, wherein the vehicle location services system determines a following distance of the vehicle with respect to a forward vehicle.

16. The safe driving incentive system of claim 15, wherein an incident of tailgating, wherein the monitored vehicle is below a tailgate threshold distance reduces the driver rating.

17. The safe driving incentive system of claim 1, wherein a mobile phone has a system App that interfaces with the monitoring system to provide driving metrics.

18. The safe driving incentive system of claim 1, wherein the mobile phone is coupled with the monitored vehicle to receive information from the vehicle location services system.

19. The safe driving incentive system of claim 1, wherein the monitoring system comprise an On-board diagnostic (OBD) device that monitors driving metrics.

20. The safe driving incentive system of claim 1, wherein the monitoring system produces a speeding alert when speeding is detected.

21. The safe driving incentive system of claim 1, wherein the speeding alert is an audible alert.

22. The safe driving incentive system of claim 1, wherein the driver rating is displayed on a display screen of the mobile phone.

23. The safe driving incentive system of claim 1, wherein the reward payment amount is displayed on the display screen of the mobile phone.

24. The safe driving incentive system of claim 1, wherein the system App detects when a texting App is opened and reduces said driver rating when the texting App is opened while driving.

25. The safe driving incentive system of claim 1, wherein the system App disables the texting App from opening when the driver is driving.

26. The safe driving incentive system of claim 1, wherein the system App disables the texting App from producing audible incoming text alerts when the driver is driving.

27. The safe driving incentive system of claim 1, wherein the system App detects when the monitored driver is moving above a threshold speed and wherein a driving event confirmation feature is automatically displayed on the mobile phone.

28. The safe driving incentive system of claim 27, wherein the driving event confirmation feature comprises a driving event confirmation input to confirm a driving event.

29. The safe driving incentive system of claim 27, wherein the threshold speed is greater than 8 mph.

30. The safe driving incentive system of claim 27, wherein the driving event confirmation feature comprises a passenger confirmation feature having a passenger input to confirm that the monitored driver is a passenger.

31. The safe driving incentive system of claim 30, wherein the passenger confirmation feature comprises a photograph confirmation feature that stores a photograph of a driver.

32. The safe driving incentive system of claim 1, wherein the system App comprises a driving event log display comprising a list of driving events for the monitored driver.

33. The safe driving incentive system of claim 32, wherein the driving event log display comprises a date and time of a driving event.

34. The safe driving incentive system of claim 32, wherein the driving event log display comprises a starting location and final location of a driving event.

35. The safe driving incentive system of claim 32, wherein the driving event log display comprises a driver rating for the driving event.

36. The safe driving incentive system of claim 32, wherein the driving event log display comprises a passenger event indicator.

37. The safe driving incentive system of claim 36, wherein a photograph of a driver is stored for a driving event as said passenger event indicator.

38. The safe driving incentive system of claim 37, wherein the system payer can view said photograph of said driver for the driving event having the passenger event indicator.

39. The safe driving incentive system of claim 32, wherein the system payer can view the driver event log for a monitored driver.

40. The safe driving incentive system of claim 32, wherein the system payer can confirm that a driving event was a passenger event.

41. The safe driving incentive system of claim 32, wherein the system payer can delete a driving event from the driving event log.

42. The safe driving incentive system of claim 1, wherein the monitoring system detects when the driver is in a designated vehicle.

43. The safe driving incentive system of claim 1, wherein the monitoring system determines a monitored driver rating.

44. The safe driving incentive system of claim 1, wherein the monitoring system is an insurance company monitoring system; and
wherein the incentive company collects data from the insurance company monitoring system to determine the reward payment.

45. The safe driving incentive system of claim 44, wherein the reward payment is at least a portion of an insurance discount determined by the insurance company monitoring system.

46. The safe driving incentive system of claim 44, wherein the insurance company monitoring system comprises an insurance company monitoring system App that operates on a monitored driver's mobile phone and wherein the incentive company interfaces with the insurance company monitoring system App through the monitored driver's mobile phone to determine a reward payment.
PAYMENT SCENARIOS

47. The safe driving incentive system of claim 2, wherein the incentive company receives the system payment and makes the premium payment to the insurance company.

48. The safe driving incentive system of claim 47, wherein the incentive company makes the reward payment to the monitored drive.

49. The safe driving incentive system of claim 2, further comprising a financial institution that makes a reward payment.

50. The safe driving incentive system of claim 2, further comprising a financial institution that receives the system payment and facilitates the premium payment to the insurance company.

51. The safe driving incentive system of claim 50, wherein the financial institution that makes a reward payment.

52. The safe driving incentive system of claim 2, further comprising a financial institution that makes an operation payment to the incentive company.

53. The safe driving incentive system of claim 52, wherein the financial institution receives at least a portion of a loss ratio dividend payment from the insurance company.

54. A provisionally-licensed driver monitoring and recording system comprising:
a) a system App that operates on both a provisionally-licensed driver's mobile phone and a licensed driver's mobile phone;
wherein the system App utilizes a location services system of each of the provisionally-licensed driver's mobile phone and the licensed driver's mobile phone to monitor speed and location of both of these phones;
wherein the system App determines when the provisionally-licensed driver's mobile phone and a licensed driver's mobile phone have both traveled together above a driving threshold speed to indicate a training trip.

55. The provisionally-licensed driver monitoring and recording system of claim 54, wherein the location services system utilizes a global positioning system (GPS) of both the provisionally-licensed driver's mobile phone and the licensed driver's mobile phone.

56. The provisionally-licensed driver monitoring and recording system of claim 54, wherein the system App records a time of a training trip.

57. The provisionally-licensed driver monitoring and recording system of claim 54, wherein the system App records a distance of a training trip.

58. The provisionally-licensed driver monitoring and recording system of claim 54, wherein the system App further comprises a review feature, wherein a licensed driver confirms a training trip.

59. The provisionally-licensed driver monitoring and recording system of claim 54, wherein the system App further comprises a review feature, wherein a licensed driver rejects a training trip, wherein a provisional licensed driver was a passenger on said training trip.

60. A provisionally-licensed driver monitoring and recording system of claim 54, wherein the system App utilizes the location services system of the provisionally-licensed driver's mobile phone to detect a driving speed and wherein said driving speed is compared with a posted speed limit to determine if the driver is speeding.

61. The provisionally-licensed driver monitoring and recording system of claim 60, wherein each incident of speeding reduces the provisionally-licensed driver's driver rating.

62. The provisionally-licensed driver monitoring and recording system of claim 60, wherein the system App produces a speeding alert when speeding is detected.

63. The provisionally-licensed driver monitoring and recording system of claim 60, wherein the speeding alert is an audible alert.

64. The provisionally-licensed driver monitoring and recording system of claim 60, wherein the provisionally-licensed driver's driver rating is displayed on a display screen of the mobile phone.

65. The provisionally-licensed driver monitoring and recording system of claim 60, wherein the system App detects when a texting App is opened and reduces said provisionally-licensed driver's driver rating when the texting App is opened while driving.

66. The provisionally-licensed driver monitoring and recording system of claim 65, wherein the system App disables the texting App from opening when the driver is driving.

67. The provisionally-licensed driver monitoring and recording system of claim 60, wherein the system App disables the texting App from producing audible incoming text alerts when the provisionally-licensed driver is driving.

68. The provisionally-licensed driver monitoring and recording system of claim 60, wherein the system App detects when the provisionally-licensed driver is moving above a threshold speed and wherein a driving event confirmation feature is automatically displayed on the provisionally-licensed driver's mobile phone.

69. The provisionally-licensed driver monitoring and recording system of claim 68, wherein the driving event confirmation feature comprises a driving event confirmation input to confirm a driving event.

70. The provisionally-licensed driver monitoring and recording system of claim 68, wherein the threshold speed is greater than 10 mph.

71. The provisionally-licensed driver monitoring and recording system of claim 68, wherein the driving event confirmation feature comprises a passenger confirmation feature having a passenger input to confirm that the monitored driver is a passenger.

72. The provisionally-licensed driver monitoring and recording system of claim 71, wherein the passenger confirmation feature comprises a photograph confirmation feature that stores a photograph of a driver.

73. The provisionally-licensed driver monitoring and recording system of claim 72, wherein the system App comprises a driving event log display comprising a list of driving events for the monitored driver.

74. The provisionally-licensed driver monitoring and recording system of claim 73, wherein the driving event log display comprises a date and time of a driving event.

75. The provisionally-licensed driver monitoring and recording system of claim 73, wherein the driving event log display comprises a starting location and final location of a driving event.

76. The provisionally-licensed driver monitoring and recording system of claim 73, wherein the driving event log display comprises a driver rating for the driving event.

77. The provisionally-licensed driver monitoring and recording system of claim 73, wherein the driving event log display comprises a passenger event indicator.

78. The provisionally-licensed driver monitoring and recording system of claim 77, wherein a photograph of a provisionally-licensed driver is stored for a driving event having a passenger event indicator.

79. The provisionally-licensed driver monitoring and recording system of claim 78, wherein the system App detects when the driver is in a designated vehicle.
